(19) United States
(12) Patent Application Publication
(10) Pub. No.: US 2012/0038947 A1
(43) Pub. Date: Feb. 16, 2012

(54) PRINTING DEVICE AND OPERATION METHOD THEREOF

(75) Inventor: Mitsunori NISHIO, Shizuoka (JP)

(73) Assignee: TOSHIBA TEC KABUSHIKI KAISHA, Tokyo (JP)

(21) Appl. No.: 13/178,626

(22) Filed: Jul. 8, 2011

(30) Foreign Application Priority Data
Aug. 10, 2010 (JP) 2010-179603

(51) Int. Cl. G06F 3/12

(52) U.S. Cl. 358/1.15

(57) ABSTRACT

A printing device is capable of modifying a displayed operation menu. The printing device includes printing unit configured to print on a recording medium and a display unit in communication with the printing unit. The display unit is configured to display operation information thereon. The printing device further includes an operation unit configured to allow a user to input a user instruction onto the display unit; and a control unit configured to control the display unit to display an operation menu with a plurality of levels, each of the plurality of levels having a plurality of items, and further configured to change the display of an item of the plurality of items based on the user instruction.

### CROSS-REFERENCE TO RELATED APPLICATIONS

This application is based upon and claims the benefit of priority from Japanese Patent Application No. 2010-179603, filed on Aug. 10, 2010, the entire contents of which are incorporated herein by reference.

### FIELD

Embodiments described herein relate generally to a printing device and an operation method of a printing device in which an operator or user is able to freely move (or shift) a particular title of a plurality of titles (or items) displayed on an operation menu screen from a current position to another so that operability of the printing device is improved.

### BACKGROUND

Printing devices have multiple functions and applications requiring a considerable number of mode settings including print settings, paper selection, character (or font) settings, barcode printing or the like. This allows an operator or user to adjust various settings as required for printing. As a result, a significant amount of data storage is required to implement an operation menu that provides various mode settings.

Such printing devices provide an operation menu screen for selecting an item from a plurality of items (or options such as printing modes) with a hierarchical structure. In the printing device, in order to select a desired title from a plurality of titles (or items) displayed on the operation menu screen, for example, to set a printing method for a “Test Printing” to be a “Transfer” type, the operator needs to follow a top-down sequence of items in the hierarchical structured menu provided on the screen to reach the item “Transfer.” With this arrangement, if the operator needs to repeatedly perform the same operation by selecting the same item in the menu, the operator may perform similar time-consuming operations by going through the hierarchical structured menu items.

### BRIEF DESCRIPTION OF THE DRAWINGS

FIG. 1 is a perspective view showing an outer appearance of a printing device according to one illustrative embodiment.

FIG. 2 shows an outer appearance of an operation unit and a display unit provided in a printing device according to one illustrative embodiment.

FIG. 3 is a block diagram showing a functional configuration of a printing device according to one illustrative embodiment.

FIG. 4 is a table showing a hierarchical structure of an operation menu screen according to one illustrative embodiment.

FIG. 5 is a flowchart showing an operation method for use in a printing device according to another embodiment.

FIGS. 6A to 6C respectively show exemplary procedures for transitioning between items in a hierarchical structured operation menu and the generation of a new hierarchical structured operation menu, respectively.

### DETAILED DESCRIPTION

According to one embodiment, a printing device capable of modifying a displayed operation menu is disclosed. The printing device includes printing unit configured to print on a recording medium and a display unit in communication with the printing unit. The display unit is configured to display operation information thereon. The printing device further includes an operation unit configured to allow a user to input a user instruction onto the display unit; and a control unit configured to control the display unit to display an operation menu with a plurality of levels, each of the plurality of levels having a plurality of items, and further configured to change a display of an item of the plurality of items based on the user instruction. A change of display may include a change of order, a change in appearance, and a change in placement etc. Further, the control unit may change an order of the plurality of levels, based on the user instruction provided from the operation unit.

Embodiments will now be described in detail with reference to the drawings.

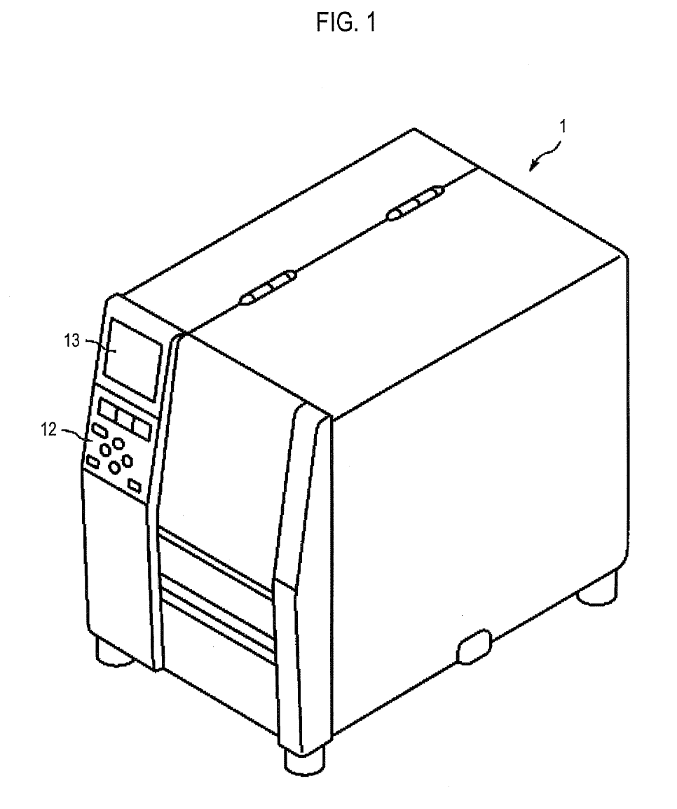

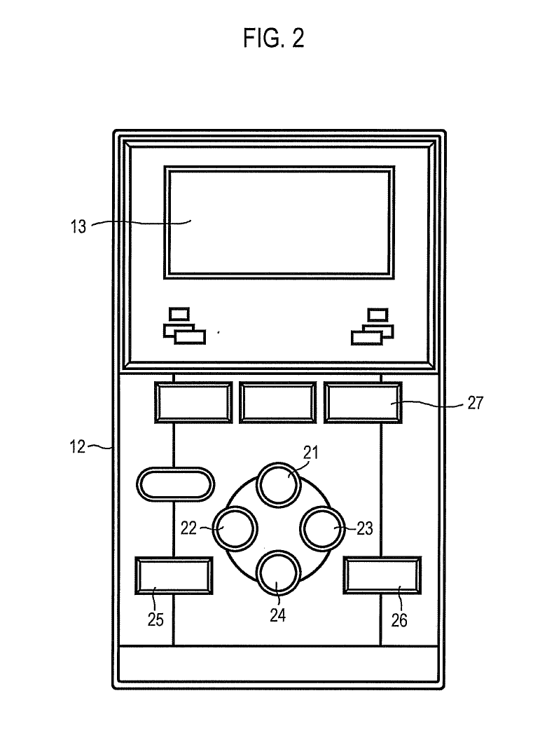

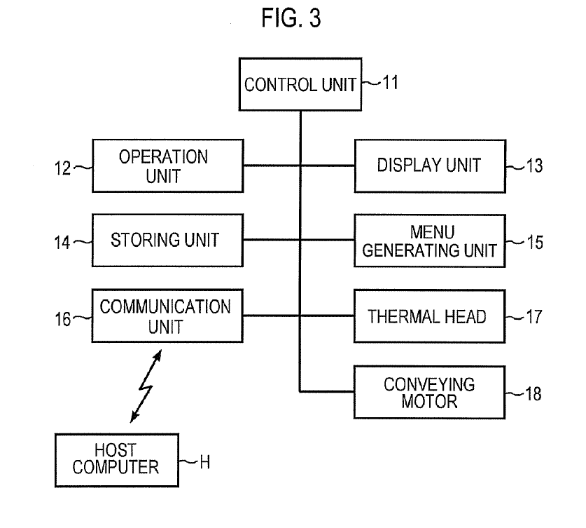

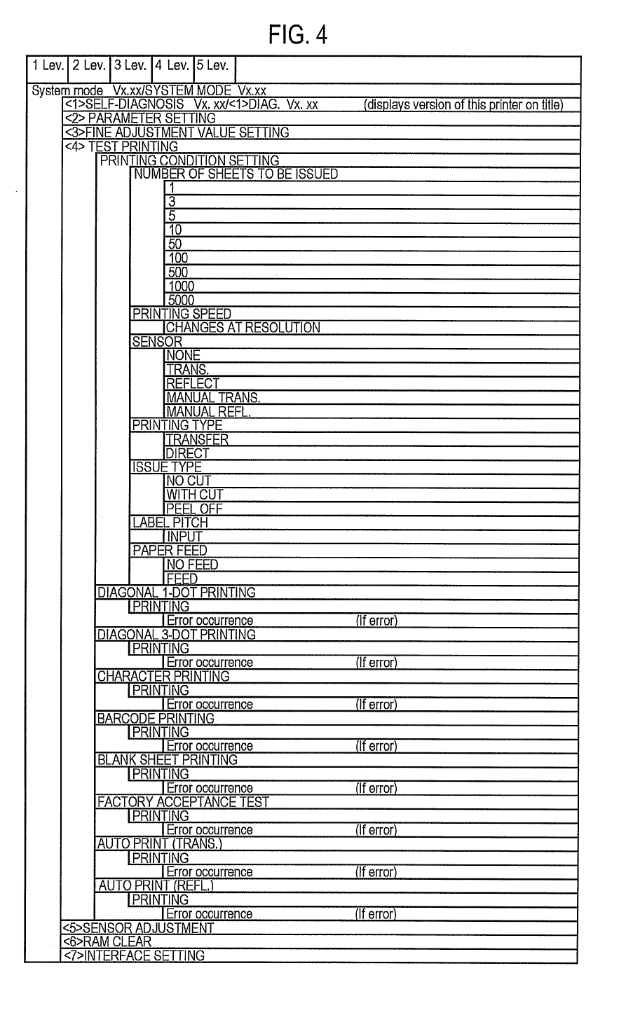

Now, a detailed description will be made as to a printing device 1 according to one illustrative embodiment with reference to FIGS. 1 to 3. As shown in FIGS. 1 to 3, the printing device 1 includes a control unit 11 configured to control the entire operation of the printing device 1, an operation unit 12 disposed in front of the printing device 1 and configured to transmit operation signals to the control unit 11 in response to an operational input by a user (or operator). The printing device 1 further includes a display unit 13 implemented by, for example, an LCD (liquid crystal display), and configured to display an operation menu or the like thereon, which will be described later. The printing device 1 further includes a storage unit 14 implemented by a read only memory (ROM), a random access memory (RAM) or the like, and configured to store operation information, setting information, operation programs or the like therein. The printing device 1 further includes a menu generating unit 15 configured to generate a newly changed operation menu (see FIG. 4; which will be described later) based on the setting information or the operational input provided from the operation unit 12, and a communication unit 16 configured to communicate with an external device, for example, a host computer H. The printing device 1 further includes a thermal head 17 configured to print on a recording medium such as a label under the control of the control unit 11, and a conveying motor 18 configured to convey, for example, a recording medium (e.g., label) attached to a backing sheet. As shown in FIG. 2, the operation unit 12 includes arrow (or direction) keys (e.g., an upward arrow key 21, a leftward arrow key 22, a rightward arrow key 23, a downward arrow key 24), a Cancel key 25, an Enter key 26, and a Pause key 27.

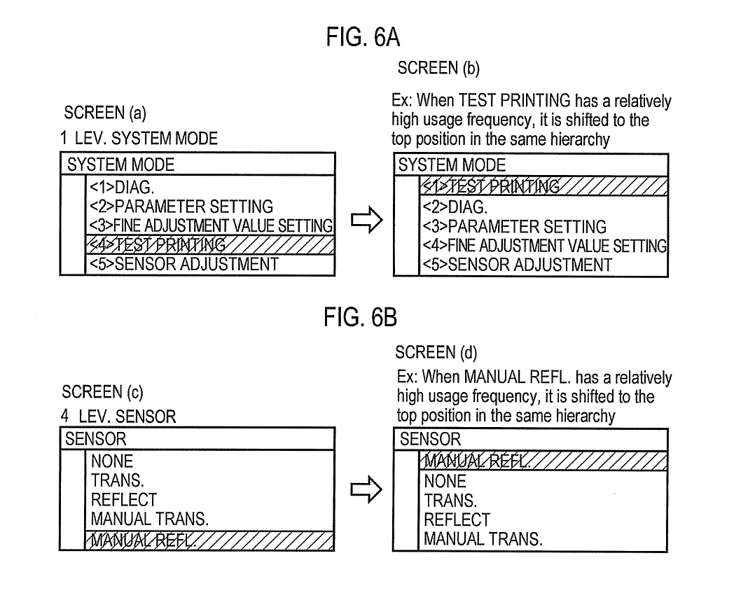

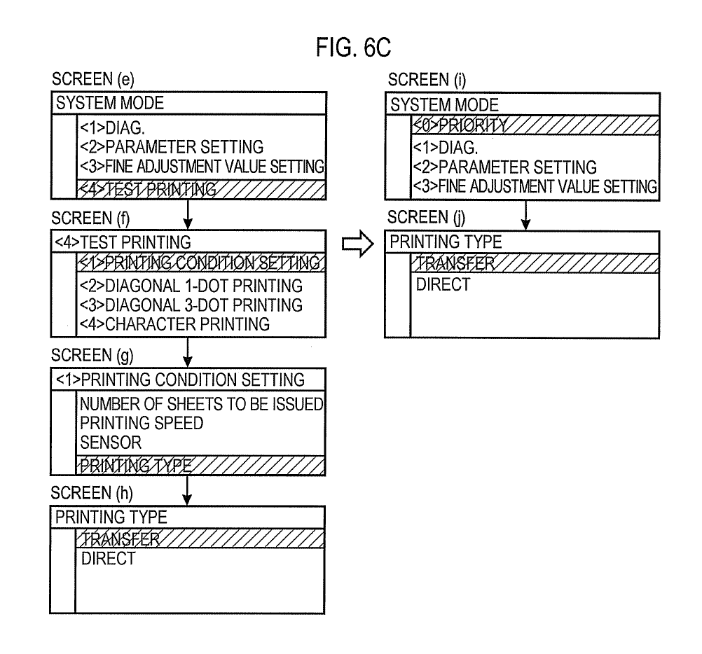

The printing device 1 with the above-described configuration allows the thermal head 17 to print, for example, price information, onto the label attached on the backing sheet, in response to the operational input provided from the operation unit 12 or the host computer H under the control of the control unit 11. Thereafter, the printing device 1 allows the conveying motor 18 to convey the backing sheet under the control of the control unit 11 so that the printed recording medium (e.g., the printed label) is discharged outside the printing device 1 through an outlet. FIGS. 6A to 6C illustrates an example of such an operation in which the user performs the selection operations on operation menu screens with the use of the upward arrow key 21, the leftward arrow key 22, the rightward arrow key 23, the downward arrow key 24, the Cancel key 25, the Enter key 26 or the like as shown in FIG. 2.

The operation menu screens as shown in FIGS. 6A to 6C are generated and managed by the menu generating unit 15 under the control of the control unit 11 of the printing device 1. Further, in FIGS. 6A to 6C, based on the hierarchical menu structure as shown in FIG. 4, a title (or item) of a higher level is listed together with selectable subtitles (or subitems) of a lower level linked to the higher level. Specifically, FIG. 6A shows an initial operation menu screen relevant to a title “SYSTEM MODE” of a first level (this term “level” is simply shown as “Lev.” in the drawings). FIG. 6B shows an operation menu screen relevant to an item “SENSOR” of a fourth level.

For example, travelling from the operation menu screen of the title “SYSTEM MODE” (of the first level in the hierarchical menu structure) as shown in FIG. 6A to the screen of the item “SENSOR” (of the fourth level) as shown in FIG. 6B requires a sequence of at least three operations using one or more of the upward arrow key 21, the leftward arrow key 22, the rightward arrow key 23, the downward arrow key 24, the Cancel key 25, the Enter key 26 or the like. Specifically, these operations may include: first selecting an item “TEST PRINTING” (of a second level) from items listed in the operation menu screen of the title “SYSTEM MODE” (i.e., the first level) by pressing any one of the arrow (or direction) keys, and performing a transition to a list of items under the selected item “TEST PRINTING” by pressing the Enter key 26; then selecting an item “PRINTING CONDITION SETTING” (of a third level) from items listed in the operation menu screen of the items “TEST PRINTING” (of the second level) by pressing any one of the arrow keys, and performing a transition to a list of items under the selected item “PRINTING CONDITION SETTING” by pressing the Enter key 26; and selecting an item “SENSOR” from items listed in the operation menu screen of the item “PRINTING CONDITION SETTING” (of the third level) by pressing any of the arrow keys, and performing a transition to a list of items under the selected item “SENSOR” by pressing the Enter key 26.

In other words, the operation menu is provided in the hierarchical structure as shown in FIG. 4 so that an item of a selected level is listed together with selectable subitems of a lower level. Specifically, listed in the first level is the title “SYSTEM MODE.” Listed in the second level are items of “<1>SELF-DIAGNOSIS,” “<2>PARAMETER SETTING” “<3>FINE ADJUSTMENT VALUE SETTING,” “<4>TEST PRINTING,” “<5>SENSOR ADJUSTMENT,” “<6>RAM CLEAR,” and “<7>INTERFACE SETTING.” Further, for example, under the item “<4>TEST PRINTING” of the second level, listed as selectable options in the third level are items “PRINTING CONDITION SETTING,” “DIAGONAL 1-DOT PRINTING,” “DIAGONAL 3-DOT PRINTING,” “CHARACTER PRINTING,” “BARCODE PRINTING,” “BLANK SHEET PRINTING,” “FACTORY ACCEPTANCE TEST,” “AUTO PRINT (TRANS.)” and “AUTO PRINT (REFL.).”

Further, under the item “PRINTING CONDITION SETTING” of the third level, listed as selectable options in the fourth level are items “NUMBER OF SHEETS TO BE ISSUED,” “PRINTING SPEED,” “SENSOR,” “PRINTING TYPE,” “ISSUE TYPE,” “LABEL PITCH,” and “PAPER FEED.” Further, for example, under the item “NUMBER OF SHEETS TO BE ISSUED” of the fourth level, listed as selectable options in a fifth level are “1,” “3,” “5,” “10,” “50,” “100,” “500,”“1000,” “5000,” or the like. Further, under the item “PRINTING SPEED” of the fourth level, listed as a selectable option of the fifth level is “CHANGE AT RESOLUTION,” and, under the item “SENSOR” of the fourth level, listed as selectable options of the fifth level are “NONE,” transmission “TRANS,” reflection “REFLECT,” transmission (manual) “MANUAL TRANS,” reflection (manual) “MANUAL REFL.” Further, under the item “PRINTING TYPE” of the fourth level, listed as selectable options of the fifth level are thermal transfer “TRANSFER” and heat-sensation “DIRECT.” Further, under the item “LABEL PITCH” of the fourth level, listed as a selectable option of the fifth level is “INPUT,” and under the item “PAPER FEED” of the fourth level, listed as selectable options of the fifth level are “NO FEED” and “FEED.”

In the operation menu as described above, as an example, it is assumed that the user often selects and uses a sequence of the title “SYSTEM MODE,” the item “<4>TEST PRINTING,” the item “<1>PRINTING CONDITION SETTING,” the item “PRINTING TYPE” and the option “TRANSFER.” Selecting such sequence of items (and performing a transition to a related list of items) requires performing a sequence of at least four operations, which may be unduly troublesome for the user. The present disclosure provides some embodiments of a method for reducing such troublesome operations and thus improving operability.

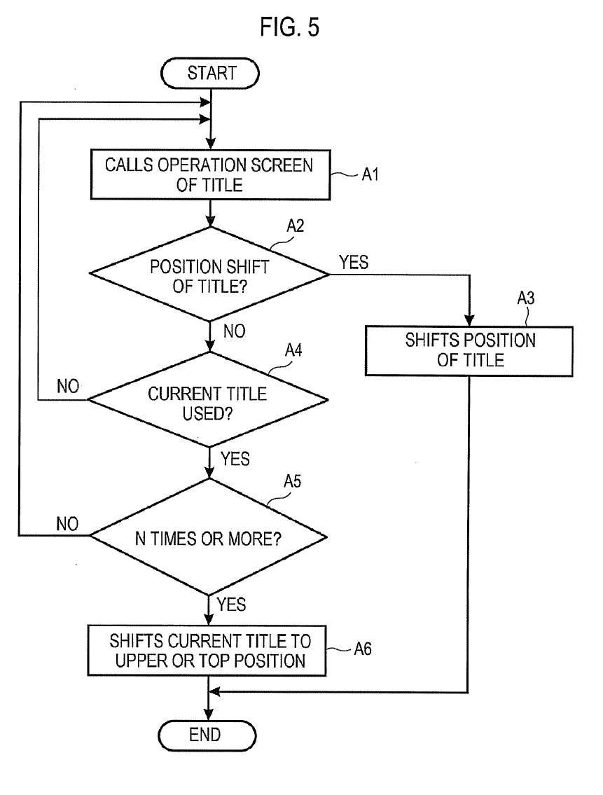

FIG. 5 is a flowchart showing an operation method for use in a printing device according to one embodiment. As explained in a flowchart of FIG. 5, in the printing device 1 according to the present embodiment, the user may select and move a particular item of a plurality of items listed in the operation menu screen with the use of the operation unit 12 so that such an item can be quickly displayed to be selected on the operation menu screen without repeatedly performing the troublesome operations in the hierarchical structured menu as described above.

Specifically, as shown in FIG. 5, when the printing device 1 is powered on, the control unit 11 controls the display unit 13 (see FIG. 1) to display thereon the operation menu screen of the title “SYSTEM MODE” (of the first level) having a plurality of items of the second level linked to the first level, as shown in SCREEN (a) of FIG. 6A. After that, for example, when the user selects the item “SENSOR” of the fourth level through the hierarchical structured menu by means of the operation unit 12, the control unit 11 controls the display unit 13 to display the operation menu screen showing a list of items of the fifth level under the item “SENSOR” of the fourth level as shown in SCREEN (c) of FIG. 6B in response to the user's selection input. Then, the user selects the item “MANUAL REFL.” listed under the item “SENSOR” (e.g., by pressing any one of the arrow (or direction) keys and the Enter key 26) (Act A1). In accordance with the present embodiment, the user may select a desired title among a plurality of titles (or items) displayed on the operation menu screen and move (or shift) the same from a current poison to another. Specifically, the control unit 11 determines whether an instruction for changing a position of the selected title (or item) is input by the user (e.g., by pressing a certain key on the operation unit 12) (Act A2). If the determination result is YES at Act A2, the control unit 11 changes (or moves) the position of the selected title (or item) in response to the instruction (Act A3). In this embodiment, as shown in SCREEN (c) and (d) of FIG. 6B, the item “MANUAL REFL.” having been placed in the fifth line on the list of the fifth level items under the “SENSOR” of the fourth level is moved to the top line within the same list. In this way, the position of the selected item of the plurality of items listed in the operation menu screen of the fifth level is changed, thus eliminating an operation of moving a cursor (i.e., an operation of manipulating any of the arrow keys) downward on the operation menu screen.

While in this embodiment, the position of the item selected by the user has been explained to be changed on the identical level of the hierarchical structured menu, embodiments are not limited thereto. For example, in an alternate embodiment, the position of the selected item may be moved between different levels in the hierarchical structured menu, for example, from a lower level to a higher level or the highest level. Specifically, for example, as shown in SCREEN (e) to (h) of FIG. 6C, displaying and selecting the item “PRINTING TYPE: TRANSFER” of the fifth level requires a sequence of at least four operations using the arrow keys and the Enter key as described above: (1) selecting the item “<4>TEST PRINTING” from the items listed under the title “SYSTEM MODE”; (2) selecting the item “<1>PRINTING CONDITION SETTING” from the items listed under the item “<4>TEST PRINTING”; (3) selecting the item “PRINTING TYPE” from the items listed under the item “<1>PRINTING CONDITION SETTING”; and (4) selecting the item “TRANSFER” from items listed under the item “PRINTING TYPE.”

In a certain embodiment, the user may designate the item “TRANSFER” among the items listed in the operation menu screen of the item “PRINTING TYPE” as a priority item (e.g., by pressing a certain key on the operation unit 12) so that the designated item “TRANSFER” is listed and displayed under the title “<0>PRIORITY” of the first level as shown in SCREEN (i) and (j) of FIG. 6C. When the initial operation menu screen is displayed (or the operation menu screen is triggered to display), the title “<0>PRIORITY” may be immediately displayed thereon (without requiring the operation to follow further the lower levels of items). Therefore, the user may simply click the title “<0>PRIORITY” displayed on the initial operation menu screen, thereby quickly displaying and selecting the item “PRINTING TYPE: TRANSFER.” As a result, operations of manipulating the arrow keys and the Enter key may be significantly decreased. In some embodiments, a plurality of titles “PRIORITY” may be provided in the initial operation menu screen in such a manner that, for example, the item “PRINTING TYPE: TRANSFER” is registered to be placed in a first title “<0>PRIORITY 1,” the item “NUMBER OF SHEETS TO BE ISSUED: 1” is registered to be placed in a second title “<0>PRIORITY 2,” and so on.

In an alternate embodiment, the user may previously set a “usage number (frequency) of item (or title)” and a “destination of item (or title).” In this embodiment, the control unit 11 counts the frequency of using a respective item (or title) during a certain time period, and controls the respective item to be automatically moved (or shifted) to the preset destination when the usage number meets a preset usage number. This may eliminate the need for the operator to manually designate the displacement (or shift) and destination of the item, as described above

Specifically, the control unit 11 determines whether a current selected item was used (Act A4). If the determination result is YES, the control unit 11 determines whether the current selected item was used N times or more during a certain time period (e.g., one month) (Act A5). In Act A5, if the control unit 11 determines that the current selected item was not used N times or more, the process returns to Act A1 where the same operation as described above is repeated. On the other hand, in Act A5, if the control unit 11 determines that the current selected item was used N times or more, it moves the current selected item to a selected position (e.g., an upper line or a top line within the list on which the current selected item is listed or a certain line in the list on which the current selected item was not listed) (Act A6). For example, the item “MANUAL REFL.” that is placed at a fifth line on the list of the operation menu screen of the item “SENSOR” of the fourth level as shown in SCREEN (c) of FIG. 6B, may be moved to a first line (i.e., the top line) on the list as shown in SCREEN (d) of FIG. 6B. Alternatively, the item “MANUAL REFL.” may be moved to the top line on the list of the operation menu screen of the first level. Still alternatively, the amount of the displacement of the item may be determined according to the usage number.

As described above, in the above embodiments, conditions of the destination and the displacement of an item (or title) may be set as one chooses, which allows the item to be automatically moved under the control of the control unit 11 according to the usage frequency of that item. Therefore, the user can easily select an item (or title) with a relatively high usage frequency, thus improving operability of the printing device 1.

As used in this application, entities for executing the operations can refer to a computer- related entity, either hardware, a combination of hardware and software, software, or software in execution. For example, an entity for executing an operation can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and an entity can be localized on one apparatus and/or distributed between two or more apparatuses.

The program for realizing the functions can be recorded in the apparatus, can be downloaded through a network to the apparatus and can be installed in the apparatus from a computer readable storage medium storing the program therein. A form of the computer readable storage medium can be any form as long as the computer readable storage medium can store programs and is readable by the apparatus such as a disk type ROM and a solid-state computer storage media. The functions obtained by installation or download in advance in this way can be realized in cooperation with an OS (Operating System) in the apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printing device, comprising:
a printing unit configured to print on a recording medium;
a display unit in communication with the printing unit, the display unit configured to display operation information thereon;
an operation unit configured to allow a user to input a user instruction onto the display unit; and
a control unit configured to control the display unit to display an operation menu with a plurality of levels, each of the plurality of levels having a plurality of items, and further configured to change a display of an item of the plurality of items based on the user instruction.

2. The device of claim 1, wherein, based on the user instruction, the control unit controls an order of the plurality of levels based on the user instruction.

3. The device of claim 1, wherein, when a usage number of an item of the plurality of items exceeds a predetermined number, the control unit changes the display of the plurality of levels.

4. The device of claim 1, wherein, when a usage number of an item of the plurality of items exceeds a set number, the control unit changes a displaying order of the plurality of items within a particular level of the plurality of levels.

5. The device of claim 4, wherein the control unit sets a position where the item is displayed in the particular level based on the predetermined number and the user instruction provided from the operation unit.

6. A method, for use in a printing device including a printing unit configured to print on a recording medium, an operation unit configured to allow a user to input a user instruction, and a display unit configured to display operation information thereon, the method comprising:
displaying an operation menu with a plurality of levels each having a plurality of items on the display unit; and
changing, based on the user instruction provided from the operation unit, at least one of a display of the plurality of levels and a display of the plurality of items.

7. The method of claim 6, wherein changing the display of the plurality of levels includes changing a selected level of the plurality of levels to the highest level, based on the user instruction provided from the operation unit.

8. The method of claim 6, wherein the display of the plurality of levels is changed when a usage of a particular item of the plurality of items exceeds a set number.

9. The method of claim 6, wherein the display of the plurality of items within a particular level of the plurality of levels is changed when a usage number of a particular item of the plurality of items exceeds a set number.

10. The method of claim 9, wherein the changing includes setting a position where the particular item of the plurality of items is displayed within the particular level, based on the set number and the user instruction provided from the operation unit.

11. A computer-readable storage medium that stores an executable program which, when executed by a printing device including a printing unit configured to print on a recording medium, an operation unit configured to allow a user to input a user instruction, and a display unit configured to display operation information thereon, performs the operations of:
displaying an operation menu with a plurality of levels each having a plurality of items on the display unit; and
changing at least one of a level of a particular one of the plurality of levels where a particular one of the plurality of items is displayed and a displaying order of the particular item within the particular level, based on the user instruction provided from the operation unit.

12. The medium of claim 11, wherein the changing includes changing the particular level to the highest one of the plurality of levels, based on the user instruction provided from the operation unit.

13. The medium of claim 11, wherein the level of the particular level is changed when a usage number of the particular item exceeds a predetermined number.

14. The medium of claim 11, wherein the displaying order of the particular item within the particular level is changed when a usage number of the particular item exceeds a predetermined number.

15. The medium of claim 14, wherein the changing includes setting a position where the particular item is displayed within the particular level and the predetermined number, based on the user instruction provided from the operation unit.
